(19) United States
(12) Patent Application Publication
(10) Pub. No.: US 2012/0025949 A1
(43) Pub. Date: Feb. 2, 2012

(54) Concurrent Infrared Signal, Single Thread Low Power Protocol and System for Pet Control

(76) Inventor: Matthew H. Reed, Lombard, IL (US)

(21) Appl. No.: 13/086,472

(22) Filed: Apr. 14, 2011

Related U.S. Application Data
(60) Provisional application No. 61/368,683, filed on Jul. 29, 2010.

(51) Int. Cl. G05B 19/00; H04B 10/00; H04L 27/00

(52) U.S. Cl. 340/5.7; 375/259; 398/130

(57) ABSTRACT

A method and system for a concurrent infrared signal, single thread low power protocol comprises transitioning a remote signal during a first fraction of a bit-period and transitioning another remote signal during a later equal fraction of another bit-period. Additionally, the method includes receiving and decoding two remote signals as a single overlapping signal thread. The disclosed system comprises multiple identifying (ID) remote transceiver units, a pet collar for each ID unit and a base unit attached to a mechanical apparatus for controlling access to food and/or a pet door. Wake-up bursts broadcast by the base unit synchronize to the ID units to the base followed by a rest and a subsequent type indicator preamble to the transmission of unique ID codes from the ID units appended by a battery indicator code. A programmable processor and logic in the base enables the mechanical apparatus based on decoding of the ID codes.

### BACKGROUND OF THE INVENTION

A communication system comprising a single transmitter and receiver may process signals in a synchronous or asynchronous protocol with little difference to performance either way. Systems employing multiple transmitters nevertheless are required to synchronize transmitters for serial decoding unless redundant circuitry is employed for parallel decoding and processing. However, traditional infrared systems operating on line-of-sight handshaking protocol may experience interference from multiple synchronized transmitters due to interference of multiple signals of same or similar frequencies.

On the other hand, portable communication systems usually employ asynchronous communications protocol to avoid a continuous running clock and to save battery power. Some portable systems run a continuous clock at one of the receiver or the transmitter sides to save some power. However, a base unit must interrogate each ID unit as it is still a one to one interacting system. This means that each ID unit must receive and decode long messages from the base unit, which will limit battery life as well as be time consuming

Manchester code, a widely used communications protocol, always has a transition at the middle of each bit-period. The direction of the mid-bit transition indicates the value of the data being conveyed in a message. Transitions at the start of a bit-period are overhead and do not signify data. Therefore, a digital ‘1’ may be expressed by a low-to-high transition and a digital ‘0’ by high-to-low transition (according to IEEE 802.3 nomenclature) at the middle of each bit-period.

### SUMMARY OF THE INVENTION

A method and system for a concurrent infrared signal, single thread low power protocol is disclosed. The method comprises assigning a first digital data value to a negative transition remote signal and assigning a second complementary digital data value to a positive transition remote signal concurrent in the same or another bit-period. The method also includes transitioning one of the sloping signals during a first fraction of the bit-period and transitioning the other sloping signal during another fraction or last fraction of the same or another bit-period. A return-to-zero fraction of the bit-period occurs between the first and subsequent fractional bit-periods. Additionally, the method includes combining and decoding respective data from two of the transitioning signals as a single thread overlapping signal at the base unit.

An embodiment of the disclosed method for a communications to protocol comprises assigning a ‘1’ digital value to the negative sloping signal and a ‘0’ digital value to the positive sloping signal. The embodiment further comprises transitioning the ‘1’ digital signal during the first third of the bit-period and transitioning the ‘0’ digital signal during a later third of the same or another bit-period.

The disclosed communications protocol further comprises a series of synchronizing bursts broadcast by a base transceiver to identifying units (ID units). The three bursts are followed by a rest and a subsequent preamble to the transmission of unique ID codes from the ID units to the base. The ID code transmission may be appended by battery level indicators.

The disclosed system employing the disclosed communications protocol comprises a single base transceiver unit and multiple identifying (ID) transceiver units. The disclosed system also comprises a pet collar for each of the ID units. The base transceiver unit comprises a digital processor attached to a mechanical apparatus and circuitry for enabling and controlling access to a food in a sustenance receptacle through a barrier such as a lid and/or a pet door. The processor may be programmed with a disclosed iProtocol which determines when each pet may feed and when each pet may enter and egress the feeding area. For instance, where the lids to two dishes are enabled and controlled by the base unit and both pets are present in the feeding area, an override of both lids may prevent them from opening until only a single pet is present and then that pet's lid only will open.

Other aspects and advantages of embodiments of the disclosure may become apparent from the following detailed description, taken in conjunction with the accompanying drawings, illustrated by way of example of the principles of the disclosure.

### BRIEF DESCRIPTION OF THE DRAWINGS

FIG. 1 depicts a low power system for a concurrent signal, single thread protocol controlling pet food and/or travel in accordance with an embodiment of the present disclosure.

FIG. 2a depicts a digital ‘1’ of the disclosed concurrent signal, single to thread protocol during a first third of a single bit-period in accordance with an embodiment of the present disclosure.

FIG. 2b depicts a digital ‘0’ of the disclosed concurrent signal, single thread protocol during a later third of a single bit-period in accordance with an embodiment of the present disclosure.

FIG. 2c depicts a single overlapping signal from digital ‘1’ and digital ‘0 concurrent signals in a single thread protocol as received by a base transceiver unit in accordance with an embodiment of the present disclosure.

FIG. 3 depicts three synchronization bursts broadcast from a base transceiver unit followed by a waiting period and a preamble transmitted from the ID units in accordance with an embodiment of the present disclosure.

FIG. 4 depicts the transmission and reception of identifier codes from a first and a second ID unit to a transceiver base unit in accordance with an embodiment of the present disclosure.

FIG. 5 depicts the transmission and reception of battery indicator code for two remote ID units to a transceiver base unit in accordance with an embodiment of the present disclosure.

FIG. 6 is a flow chart of a method for concurrent signal, single thread protocol for a low power system in accordance with an embodiment of the present description.

FIG. 7 is a flow chart of an embodied method for concurrent signal, single thread protocol for a low power system in accordance with an embodiment of the present description.

FIG. 8 is a flow chart of a method for concurrent signal, single thread protocol for a low power system controlling pet food and/or travel in accordance with an embodiment of the present description.

Throughout the description, similar reference numbers may be used to identify similar elements.

### DETAILED DESCRIPTION

Reference will now be made to exemplary embodiments illustrated in to the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Many households today have multiple pets. Often those pets have different dietary and medical needs and different roaming habits. Currently there is no solution to feed and contain all household pets at once in a common living area other than to keep each pet in separate secluded areas and/or to provide additional managed care. Because it is not always practical nor is it desirable to keep pets in separate quarters, an economical and reliable alternative to highly managed care is disclosed herein.

In an embodiment of the disclosure, each pet may wear at least one small infrared device (aka ‘remote unit’ herein) on a pet collar. A pet bowl adjacent the base unit may have an infrared sensor and transmitter base device (aka ‘base unit’ herein) with digital logic and/or a digital processor configured to determine which pets are present in a defined area. An area may be defined by line-of-sight for infrared embodiments. A mechanical apparatus in the base may be attached to the lid and/or the pet door to enable and control access to food lid and/or travel for a predetermined pet. The infrared device may be thought of as an area pass-key when granted or enabled by the base unit. It may be used with other devices, such as a pet-door lock, a restricted-area alarm, auto-switching camera monitoring system, and other like devices and systems. Infrared light transmitted and received in the disclosed methods and system may fall in the optical communications bandwidths between approximately 1260 Nano-meters to approximately 1675 Nano-meters.

Embodiments of the disclosed protocol and system may also employ other frequencies of the electromagnetic spectrum such as radio waves, microwaves, long waves, ultraviolet waves and other waves capable of encoding communication information. In fact, ultrasonic sound waves may be employed for applications involving the elderly and small children though obviously not to advisable for pets and animal applications. Therefore, the term ‘present’ used throughout the disclosure may be defined to be when a remote unit and a base are able to communicate via a wave medium of choice.

Other embodiments of the disclosed system and protocol may include remote identification (ID) units placed on bracelets, anklets and necklaces worn by elderly or otherwise disabled persons or small children and base units placed on gates and doors, etc. Therefore, embodiments of the disclosed method and system may enable caregivers for the elderly to allow some residents egress privileges while denying privileges to other residents with advanced needs and care in the same facility.

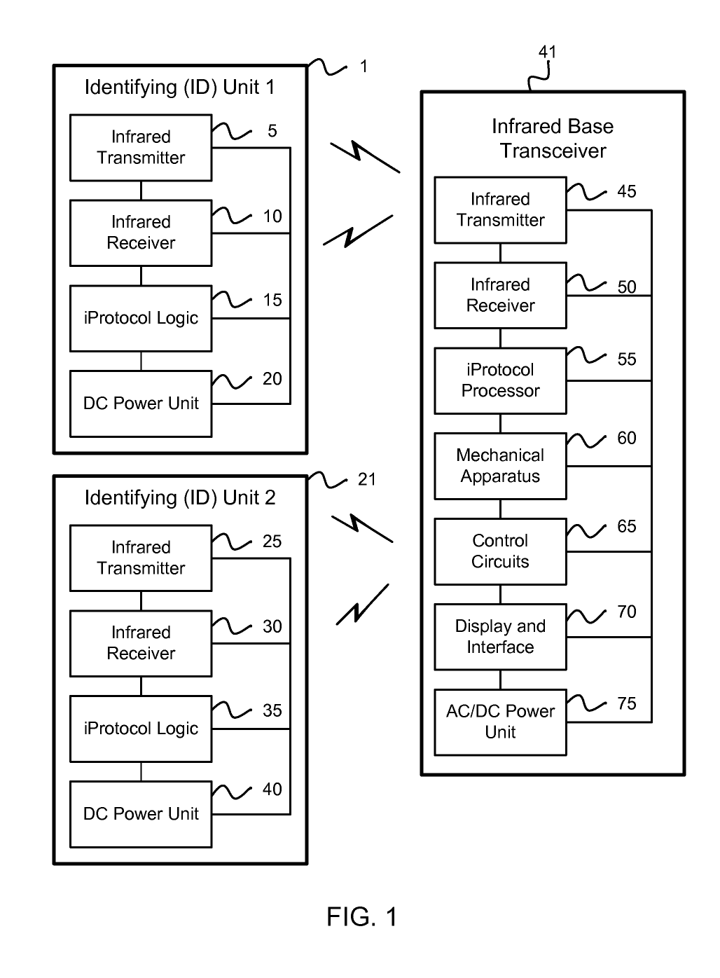

FIG. 1 depicts a low power system for a concurrent signal, single thread protocol controlling pet food and/or travel in accordance with an embodiment of the present disclosure. The disclosed protocol for overlapping concurrent signals into a single thread is also known herein as iProtocol. The embodiment comprises a first remote ID unit 1 including an infrared transmitter 5, an infrared receiver 10, an iProtocol logic unit 15 and a DC battery Power unit 20.

Additionally, a second remote ID unit 21 also comprises an infrared transmitter 25, an infrared receiver 30, an iProtocol logic unit 35 and a DC batter Power unit 40. The iProtocol logic modules of the first and second units 1 and 21 may include a clock running at a predetermined frequency to synchronize internal logic and to synchronize with a base unit clock. The remote units 1 and 21 are each configured to encode a first data value in a signal transition during a first fraction of a bit period and to encode a second complementary data value in a complementary signal transition during a last fraction of the bit period.

The base transceiver unit 41 comprises an infrared transmitter 45, an infrared receiver 50, an iProtocol logic unit 55 comprising at least one clocked logic thread, a mechanical apparatus 60, control circuits 65, a display and interface 70 and an AC/DC Power unit 75. The AC/DC power unit (alternating current/direct current) 75 may include an AC transformer and/or a DC battery backup and power the base unit 41 exclusively on AC power or battery DC power or both. The control circuits 65 may comprise analog circuits and analog to digital converter circuits for control of the mechanical apparatus 60. The control circuits 65 may also comprise a clock and digital logic circuits for internal control and to interface and synchronization to the ID units and other interfaces for test and programming The mechanical apparatus 60 may include dc motors and actuators for locking and unlocking a cover on a pet bowl and opening and closing a pet door. The term ‘thread’ used throughout the present disclosure describes the hardware required to decode respective encoded data from a single signal. Therefore, conventional infrared protocol requires two logic threads to decode two infrared signals. However, as disclosed, a single logic thread may decode respective data from two infrared signals when the iProtocol is employed.

The base unit 41 and any multiplicity of identifying (ID) transceiver units 1 and 21 may contain both infrared detectors and infrared transmitters attached to a pet's collar or to an elderly person's or child's bracelet, necklace and/or anklet. The base unit 41 may periodically transmit multiple infrared bursts of equal uptime and predetermined downtime to wake-up the remote ID units 1 and 21. The remote ID units 1 and 21 therefore may conserve power between transmitting and receiving when not processing protocol by putting circuits into a sleep state also known as a quiescent state with the exception of the receiver.

When a remote ID unit detects these bursts, it may ‘wake-up’ and use the bursts to synchronize handshaking communications with the base unit. The ID units 1 and 21 may therefore synchronize to the base unit 41 and to each other. Each present remote unit may transmit its identification (ID) code and any additional information disclosed therein such as a battery charge level indicator code appended to the ID code.

Because all ID units are synchronized to each other and to the base unit 41, transmissions from the first ID unit 1, to the base 41 may overlap with the second ID unit 21 transmission to the base 41. In order to detect overlapping infrared transmissions by multiple ID units to the base unit 41, a modified Manchester coding format is disclosed in the present application for patent. An embodiment of the disclosed concurrent infrared signal, single thread low power protocol (iProtocol) always transitions at a third each bit-period (a bit-period may be defined as the time domain of a single bit or a clock period). The slope or transition direction of the data at the one third and later third transitions indicates the digital value of the data. Data sloping downward (negative slope) at a bit transition may indicate a digital ‘1’ and data sloping upward (positive slope) at a to bit transition may indicate a digital ‘0’. More specifically, a digital ‘1’ is represented by a high level transitioning to a low level at one third the bit-time and a digital ‘0’ is represented by a low level transitioning to a high level at two thirds or three thirds the bit-time. Because of the three-way split bit-period, both logic values may occupy unique equal portions or fractions of a single bit-period and still leave one third the bit-period for a signal to return to zero, or to transition back to a non-data level. Therefore a logic ‘0’ via the overlapping conjunctive ‘AND’ with a logic ‘1’ may be detected by electronic decoding circuits. Data may be sampled during at least the two transitions of the bit-period.

Depending on the information to be transmitted, there may also be transitions at the start, middle and end of a bit-period. Transitions at the bit-period boundaries and during the middle third of a bit-period do not carry information. They exist only to place the signal in the correct state to allow a first third and another third bit transitions. The existence of guaranteed transitions allows communications signals to be self-clocking and also allows a receiver to align correctly with a transmitter. A receiver may detect if it is misaligned by a third of a bit-period.

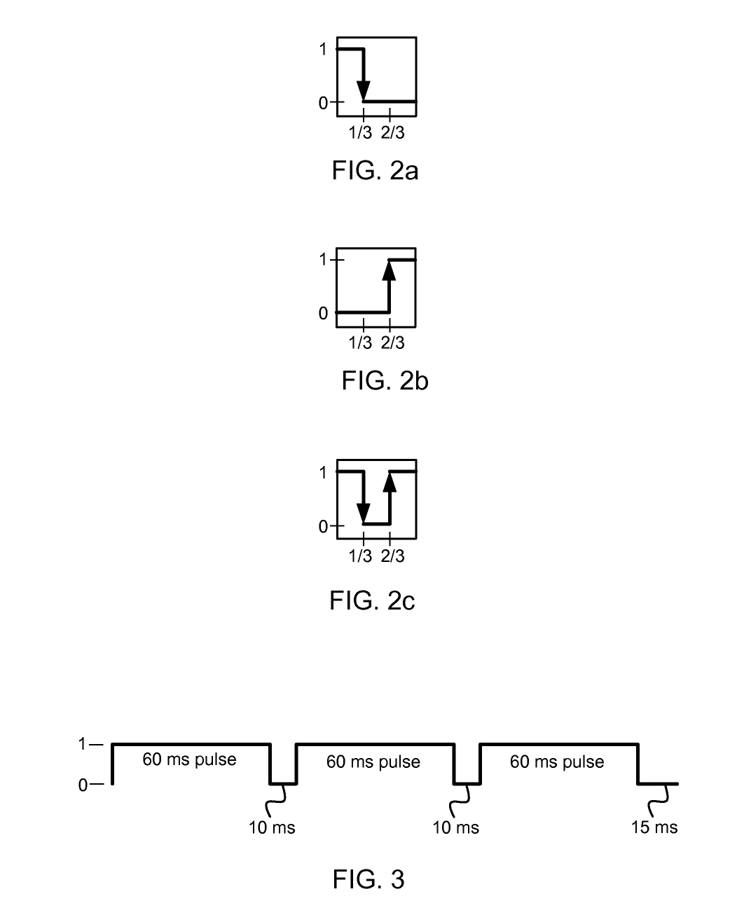

FIG. 2a depicts a digital ‘1’ of the disclosed concurrent infrared signal, single thread low power protocol during the first third of a single bit-period in accordance with an embodiment of the present disclosure. As time moves from left to right, the depicted signal makes a transition at the end of the first third of the bit-period from a high level to a lower level. The depicted signal may be a different signal than the signal of FIG. 2b or it may be the same signal in a different bit-period than the bit-period depicted. The signal depicted may return high for a ‘1’ bit or it may stay low for a ‘0’ bit in a subsequent bit-period.

FIG. 2b depicts a digital ‘0’ of the disclosed concurrent infrared signal, single thread low power protocol during a later third of a single bit-period in accordance with an embodiment of the present disclosure. As time moves from left to right, the depicted signal makes a transition at the end of the second third of the bit-period from a low level ‘0’ to a higher level ‘1’. In embodiments of the disclosure, the depicted signal makes its transition at the beginning of the third bit-period. The depicted signal may return to zero in a subsequent bit-period with to another ‘0’ bit or it may stay high for a ‘1’ bit in the first third of the subsequent bit-period.

FIG. 2c depicts a single overlapping signal from digital ‘1’ and digital ‘0 concurrent signals in a single thread protocol as received by a base transceiver unit in accordance with an embodiment of the present disclosure. As time moves from left to right, the depicted signal starts high due to the high digital ‘1’ level until the end of the first third bit-period when the signal makes a transition to a lower value and stays there until the end of the second third of the bit-period when the signal makes a transition back to the high level for the digital ‘0’. Therefore, there is no loss of data from receiving two concurrent signals into a single data thread. The single data thread received at the base may be decoded and processed by single thread circuits and logic. A thread may be defined as a single stream of data and control information that may be processed by single transceiver and single digital circuit resources.

FIG. 3 depicts the three synchronization bursts broadcast by the base device to the ID units followed by a wait period in accordance with an embodiment of the present disclosure. The base broadcasts three 60 millisecond digital ‘1’ pulses with a 70 millisecond period (two each 10 millisecond ‘0’ downtime pulses as depicted). The three bursts may be sent periodically and indiscriminately to all the ID units without any identifying information. The three bursts may be broadcast with a periodicity of two seconds nominally but the periodicity may vary as programed in the base processor as a power savings feature. The ID units use the three bursts to synchronize to the base unit and thereby synchronize to each other. The ID units wait 15 milliseconds after the last 60 millisecond pulse before transmitting information back to the base.

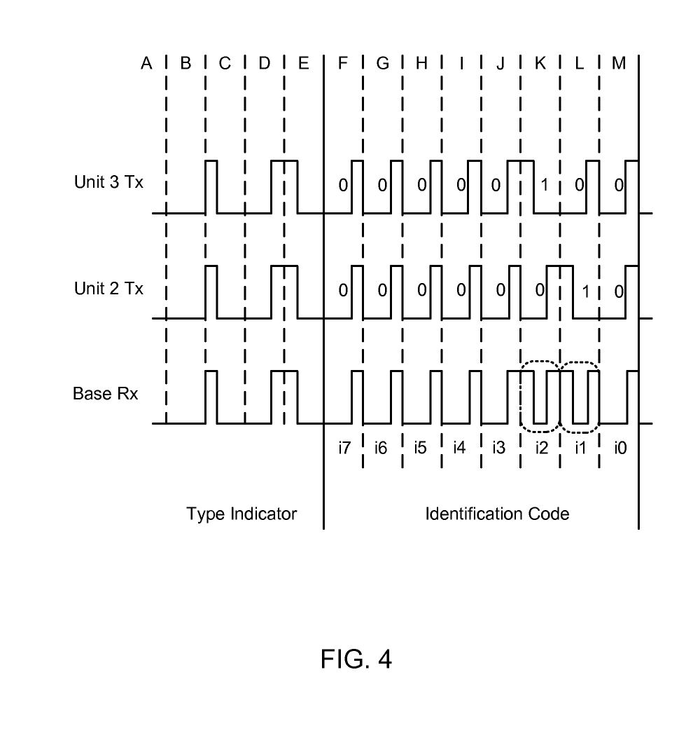

FIG. 4 depicts the transmission and reception of identifier codes from a second and a third ID unit to a base unit in accordance with an embodiment of the present disclosure. A 3bit type indicator preamble is encoded in the reply from each remote unit sent concurrently to the base unit followed by a 7 bit unique ID code word as depicted. A first data value is encoded in a first fraction of a bit period and a second complementary data value is encoded in a last fraction of the bit period. The 3 bit type indicator is depicted in bit-periods C, D and E and is the same for Units 2 and 3. The seven bit ID code is depicted in bit-periods F through

M where F precedes M in time and therefore F is most significant and M is least significant in the data stream. Unit 3 transmits the data stream 0000 0100 and unit 2 transmits the data stream 0000 0010 as shown. Also as shown, the two concurrent infrared signals are synchronized to each other since both units 2 and 3 are synchronized to the same base broadcast and are of the same information type (bit-periods C, D and E). In the scenario depicted in FIG. 4, no other ID units are present with respect to the base unit. Logic in the base unit may be designed or programmed to decode a data stream as follows below. However, other decoding schemes may be used for unique unit identification where F is least significant and M is most significant, etc.

Remote ID Unit #1: 0000 0001,

remote ID Unit #2: 0000 0010,

remote ID Unit #3: 0000 0100,

remote ID Unit #4: 0000 1000,

remote ID Unit #5: 0001 0000,

remote ID Unit #6: 0010 0000,

remote ID Unit #7: 0100 0000,

remote ID Unit #8: 1000 0000.

From the base receiver data depicted in FIG. 4, it can be seen that the ID units 2 and 3 are present with respect to the base infrared receiver. Since units 2 and 3 are both present with respect to the base unit and transmit data streams concurrently to the base, the base unit effectively ‘sees’ the logical ‘AND’ or overlapping of both a “1” and a “0” in bit periods K and L depicted by dotted circles. The base unit therefore, according to iProtocol, decodes bit periods K and L to indicate unit 3 and unit 2 are present respectively. The digital processor in the base unit may therefore activate control circuits and mechanical apparatus to open lids to separate feeding dishes or leave shut respective lids to prevent either pet from eating from the other's dish. Alternatively, a clock in the control circuit module of the base unit may open respective lids at separate feeding times as programmed into the iProtocol in the processor module. The base unit may also ensure a lid to a single feeding dish is closed when more than one pet is present to prevent both pets eating from the same dish at the same time. Similarly, the base to unit may ensure a pet door is closed to prevent an un-allowed pet tailgating an allowed pet out the door when both are detected present by the base unit according to iProtocol programming.

It is worth noting that ID units having a different type indicator code than units 2 and 3 depicted in FIG. 4 may also transmit concurrently to the base unit and be processed as a single thread by the iProtocol processor and logic in the present disclosure. With the three bit-periods C, D and E there may be 3 unique type indicator codes. However, with the provision of adding bit-periods A and B, the number of unique codes may be expanded to 5 unique pairs.

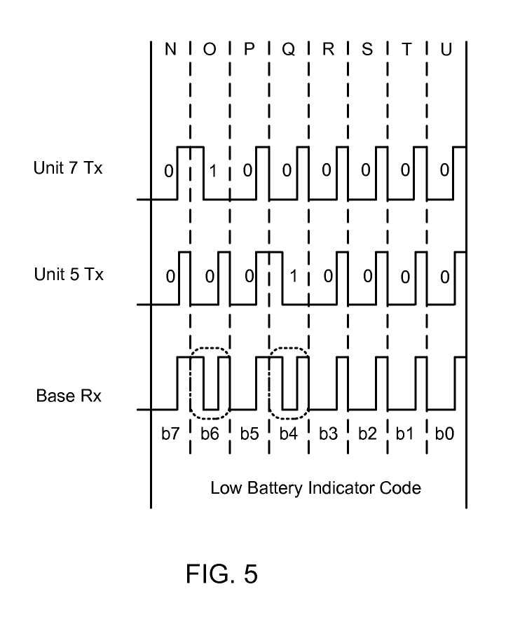

FIG. 5 depicts the transmission and reception of battery indicator code from two remote ID units to a base unit in accordance with an embodiment of the present disclosure. Low battery and battery energy level codes may be concatenated to the remote ID code transmitted from a remote to the base unit in a reply to a synchronizing burst signal. Units 5 and 7 are both ‘present’ in the scenario of FIG. 5 and have already transmitted preamble and ID codes to the base (not depicted). The base therefore receives and decodes a low battery indicator in period 0 for remote unit 5 and a low battery indicator in period Q for remote unit 7 as circled and depicted. When more than one remote unit is present, each unit may only indicate through a single predetermined and exclusive bit-period whether or not it has a low battery condition to prevent an over-write of one unit's battery level indicator onto another unit's battery level indicator.

However, when only one remote unit is present, the unit may transmit to the base through other disclosed bit schemes the specific energy level of its battery. The base unit knows from the identification code transmitted whether or not multiple units are present and decodes the battery code according to a battery energy level iProtocol. Therefore, had remote ID unit 7 transmitted the reply depicted in FIG. 5 at a time when no other units were ‘present,’ the base may have interpreted the battery code to indicate a level 7 battery energy level on a scale of 1 to 8. Likewise, had remote unit 5 transmitted the reply depicted in

FIG. 5 as a solo reply, the base would know that unit 5 had a battery energy level of 5 on a scale of 1 to 8. The base unit may therefore set an indicator on its face such as an LED to indicate a low battery for a specific remote unit and set another indicator to indicate the battery energy level for a specific remote unit.

In one embodiment of the present disclosure, battery indicators may be assigned as follows, where the rightmost bit is least significant:

unit 1 multiple low battery or any single battery level 1: 0000 0001,

unit 2 multiple low battery or any single battery level 2: 0000 0010,

unit 3 multiple low battery or any single battery level 3: 0000 0100,

unit 4 multiple low battery or any single battery level 4: 0000 1000,

unit 5 multiple low battery or any single battery level 5: 0001 0000,

unit 6 multiple low battery or any single battery level 6: 0010 0000,

unit 7 multiple low battery or any single battery level 7: 0100 0000,

unit 8 multiple low battery or any single battery level 8: 1000 0000.

Single battery level indicators may range from a digital 1 as the lowest level charge indicator to a digital 8 as the highest level charge indicator. However, other schemes are also comprised in the present disclosure for battery level indication such as a binary count (level 4=0100 highest charge, level 3=0011, level 2=0010, level 1=0001 lowest charge, etc.) using the most significant byte of the data following the ID code in a reply transmission. As the charge in a remote ID unit battery is depleted the ID unit may transmit an updated battery level indicator signal to the base. The base may record ID remote units with low battery energy indicators and activate an LED (light emitting diode) or any other indicator on the face of the base unit to signal necessary battery replacement in the ID units to avoid system failure. Indicators on the base may also indicate which remote unit has been granted or allowed ‘pass-key’ status by the base unit. However, in the event of a system failure, the disclosed method and system comprises a fail-safe default condition that will render a pet food cover open and a pet door to no-control.

The digital processor comprised in or attached to the base unit is programmable and may therefore allow tailgating of one pet through a pet door by another pet at the preference of the pet owner or caregiver. Similarly, the processor may be programmed to enable or disable a mechanical apparatus for opening a lid to a single pet feeder attached to or comprised in the base when multiple pets are present in a determined area. Alternatively, multiple pet feeder dishes and covers may be enabled and controlled separately by the programmable to processor and multiple mechanical apparatus.

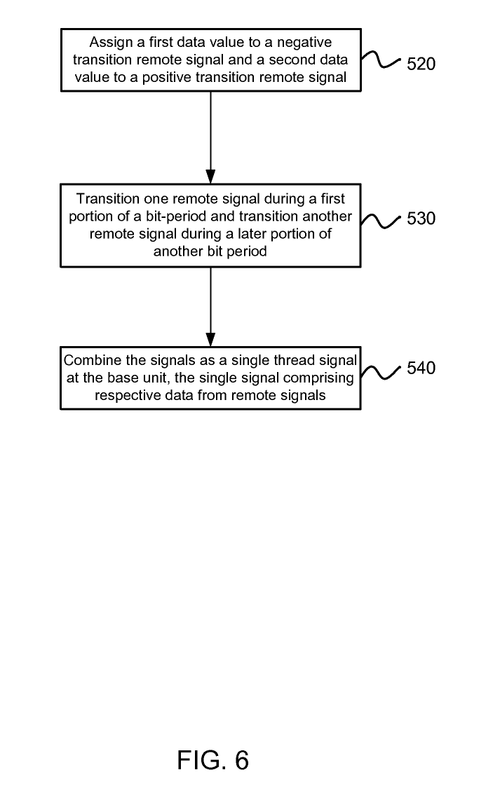

FIG. 6 is a flow chart of a method for concurrent signal, single thread protocol for a low power system in accordance with an embodiment of the present description. The method includes assigning 520 a first digital data value to a negative sloping or transition signal and assigning a second complementary digital value to a positive sloping or transition signal. The method further includes transitioning 530 one of the assigned sloping signals during a first portion or fraction of a bit-period and transitioning another assigned sloping signal during a later portion or fraction of the bit-period. The method also comprises combining 540 the signals as a single overlapping and composite thread signal at the base unit, the single signal comprising respective data from the remote signals.

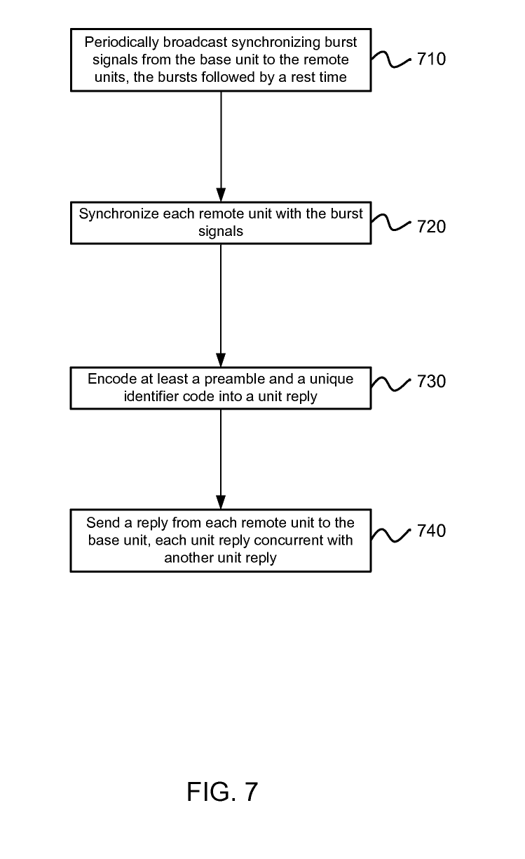

FIG. 7 is a further flow chart of a method for concurrent signal, single thread protocol for a low power system in accordance with an embodiment of the present description. The method includes periodically broadcasting 710 synchronizing burst signals from the base unit to the remote units, the bursts followed by a rest time of some 15 milliseconds. The method also includes synchronizing 720 each remote unit with the burst signals. The method further includes encoding 730 at least a preamble and a unique identifier (ID) code into a unit reply. The method additionally includes sending 740 a reply from each remote unit to the base unit, each reply concurrent with another unit reply.

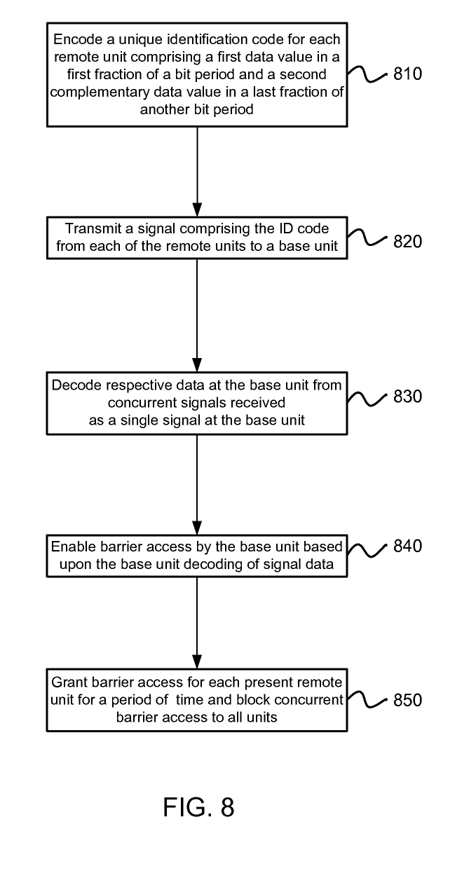

FIG. 8 is a flow chart of a method for concurrent signal, single thread protocol for a low power system controlling pet food and/or travel in accordance with an embodiment of the present description. The method includes encoding 810 a unique ID code for each remote unit comprising a first data value in a first fraction of a bit period and a second complementary data value in a last fraction of the bit period. The method also includes transmitting 820 a signal comprising the ID code from each of the remote units to a base unit. The method further includes decoding 830 respective data at the base unit from concurrent signals received and combined as a single signal at the base unit. The method additionally includes the base unit enabling 840 barrier access based upon the outcome of the decoding of the signal data by the base unit. The method yet includes granting 850 barrier access for each present remote unit for a period of time and blocking concurrent barrier access of all units.

The disclosed methods and system for pet control therefore allow for the management of multiple pets through a concurrent signal, single thread low power protocol. The system disclosed does not require separate processing of multiple discrete signals and therefore requires less hardware and processing time and therefore less power. The low power aspect and low battery indicia of the present disclosure can be critical for managed care of pets having specific dietary and/or medicinal requirements. The disclosure also applies to the managed care of the elderly and/or to small children especially with respect to access to specific areas in a home or care facility.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Furthermore, though specific embodiments of the invention have been described and illustrated, the invention is not to be limited to the specific forms or arrangements of parts so described and illustrated. The scope of the invention is to be defined by the claims and their equivalents to be included by reference in a non-provisional utility application.

What is claimed is:

1. A method for communication between a base unit and multiple remote units comprising:
assigning a first data value to a negative transition remote signal and a second data value to a positive transition remote signal;
transitioning one remote signal during a first fraction of a bit period and transitioning another remote signal during a last fraction of another bit period; and
combining the remote signals as a single thread signal at the base unit, the single signal comprising respective data from the remote signals.

2. The method for communication between a base unit and multiple remote units of claim 1, wherein a ‘1’ digital data value is assigned to the negative transition signal and a ‘0’ digital data value is assigned to the positive transition signal and the negative transition occurs in the first third of a remote bit period and the positive transition occurs in the last third of another remote bit period.

3. The method of communication between a base unit and multiple remote units of claim 1, further comprising returning-to-zero the remote signals during a fraction of the bit-period between the first and last fractional bit periods.

4. The method for communication between a base unit and multiple remote units of claim 1, wherein the remote signals comprise infrared light signals in an optical communications bandwidth range of approximately 1260 nm to approximately 1675 nm.

5. The method for communication between a base unit and multiple remote units of claim 1, wherein the remote signals comprise at least one of ultrasonic sound waves, radio waves, microwaves, long waves, ultraviolet waves and any other type of waves capable of encoding communication information.

6. The method for communication between a base unit and multiple remote units of claim 1, further comprising:
broadcasting a plurality of synchronizing burst signals from the base unit to the remote units, the bursts followed by a rest time;
synchronizing each remote unit with the base unit via the burst signals;
encoding at least a preamble and a unique identifier code into a unit reply; and
sending a reply from each remote unit to the base unit, each unit reply concurrent with another unit reply.

7. The method of communication between a base unit and multiple remote units of claim 6, wherein the preamble comprises a message type indicator, where a message type comprises unit identification and other information concerning status of a remote unit.

8. The method of communication between a base unit and multiple remote units of claim 6, further comprising encoding a battery indicator code into a unit reply indicating a low battery for one of multiple units and indicating a specific battery energy level for a single remote unit.

9. The method of communication between a base unit and multiple remote units of claim 6, wherein each of the plurality of burst signals from the base comprise equal up time and equal down time in an equal period of time.

10. The method of communication between a base unit and multiple remote units of claim 6, further comprising conserving power in the remote units between base station broadcasts and encoding and sending a reply by putting circuits in a sleep quiescent state.

11. The method of communication between a base unit and multiple remote units of claim 6, further comprising decoding respective data from both remote signals as a single signal controlling at least one of opening a door, opening a food dish, turning on a restricted-area alarm and turning on a camera monitoring system.

12. A system for communication between a base unit and multiple remote units, comprising:
a plurality of remote units, each unit comprising a transceiver, clocked logic and a power unit, the logic configured to encode a first data value in a signal transition during a first fraction of a bit period and encode a second complementary data value in a complementary signal transition during a last fraction of another bit period; and
a base unit comprising a transceiver, at least one clocked logic thread, mechanical apparatus, control circuits and a power unit, a single logic thread configured to decode as a single signal respective data values from a plurality of concurrently received signals.

13. The system for communication between a base unit and multiple remote units of claim 12, further comprising at least one receptacle adjacent to the base unit with a lid attached to the mechanical apparatus of the base unit.

14. The system for communication between a base unit and multiple remote units of claim 12, further comprising at least one pet door attached to the mechanical apparatus of the base unit.

15. The system for communication between a base unit and multiple remote units of claim 12, further comprising one of a collar, a bracelet, an anklet, and a necklace comprising a remote unit configured to be worn by one of a pet, a disabled resident and a child.

16. The system for communication between a base unit and multiple remote units of claim 12, further comprising indicators on a face of the base unit configured to visibly show a battery indicator for each remote unit and show which remote unit is granted a pass-key status by the base unit.

17. A method of controlling pet access through at least one barrier, comprising:
encoding a unique identification (ID) code for each of a plurality of remote units, each ID code comprising a first data value in a first fraction of a bit period and a second complementary data value in a last fraction of another bit period;
transmitting a signal comprising the ID code from each of the plurality of remote units to a base unit;
decoding respective ID codes from a plurality of concurrent signals received as a single signal at the base unit;
enabling a unit barrier access by the base based upon the decoding of ID coded signals; and
granting a unit barrier access for each remote unit for a period of time but blocking concurrent barrier access to all remote units.

18. The method of controlling pet access through at least one barrier of claim 17, wherein the barrier is one of a lid to a sustenance receptacle and a door to an area.

19. The method of controlling pet access through at least one barrier of claim 17, further comprising concatenating a battery indicator code to the ID code and activating an indicator on the face of the base unit signaling necessary battery replacement in the remote unit based on the battery indicator code.

20. The method of controlling pet access through at least one barrier of claim 17, further comprising defaulting to a fail-safe condition that will render a pet food cover open and a pet door to no-control upon system power failure.
